(19) United States
(12) Patent Application Publication
(10) Pub. No.: US 2026/0237017 A1
(43) Pub. Date: Aug. 13, 2026

(54) METHOD FOR ALIGNING POINT CLOUDS BASED ON SEMANTIC LABELING OF POINTS

(71) Applicant: Honda Motor Co., Ltd., Tokyo (JP)

(72) Inventors: Mathias Franzius, Offenbach/Main (DE); Archit Naik, Offenbach/Main (DE)

(73) Assignee: Honda Motor Co., Ltd., Tokyo (JP)

(21) Appl. No.: 19/052,227

(22) Filed: Feb. 12, 2025

(51) Int. Cl. G06T 3/14; G06T 7/33

(52) U.S. Cl. CPC G06T 3/14; G06T 7/344; G06T 2207/10028

(57) ABSTRACT

This disclosure relates to a method for aligning a source point cloud corresponding to a 3D object with a target point cloud corresponding to the same 3D object. The disclosure also relates to an image processing device comprising a processor configured to carry out the steps of the method. Each point of a set of points in the source point cloud and each point of a set of points in the target point cloud is associated with at least one of a plurality of semantic labels. During the method, a matching of each point of the set of points in the source point cloud is constrained to a point or points of the set of points in the target point cloud associated with the same or a similar semantic label. Based on the result of the matching, the method applies a transformation operation to the source point cloud.

### TECHNICAL FIELD

The present disclosure relates to three-dimensional (3D) data processing, for example, to Iterative Closest Point (ICP) and related methods used for aligning two point clouds. The disclosure proposes a method for aligning a source point cloud corresponding to a 3D object with a target point cloud corresponding to the same 3D object. The present disclosure also proposes an image processing device, which comprises a processor configured to carry out the method.

### BACKGROUND

Methods and algorithms for point cloud alignment (also called point cloud registration method) are used to determine a transformation (e.g., a rotation and/or translation) between two point clouds, for example, in a way that minimizes an alignment error. For instance, conventional ICP algorithms, which align two sets of 3D points by minimizing a geometric error metric, are widely used in robotics, computer vision, medical imaging, and autonomous driving. Precise point cloud alignment also plays a critical role in object localization, simultaneous localization and mapping (SLAM), and 3D reconstruction.

The conventional ICP algorithm typically comprises the following steps:
1. Match each point in a source point cloud to a closest point in a target point cloud, i.e., for each point of the source point cloud find the closest point in the target point cloud.
2. Compute a rigid transformation (e.g., rotation and/or translation) that minimizes e.g. a mean squared error between matched points.
3. Transform the source point cloud using the computed transformation.
4. Repeat the steps 1-3 until convergence is achieved (e.g., until a change in error is minimal).

### SUMMARY

The present disclosure and its aspects and implementations are further based on the following considerations of the inventors.

The conventional ICP algorithm faces limitations related to occlusion, large initial misalignment, object symmetries, as well as near-symmetric objects.

As an example, the conventional ICP algorithm is a local method, and thus typically requires a sufficiently good initial pose of the object, otherwise it may miss a global optimum. Thus, the conventional ICP algorithm often relies on an initial pose estimation of the object.

As another example, an object with symmetry (e.g., a cylinder or cuboid) has multiple valid solutions for point cloud alignment. However, some objects exhibit near-symmetries (e.g., a slightly flattened cylinder, or a cuboid with non-equal side length, or an object with a small but semantically important symmetry-breaking feature, e.g. the small handle of a large mug), which are important to align correctly. Such near-symmetries may cause local minima in the loss landscape, and can thus cause local methods like the conventional ICP algorithm to miss the correct global optimum. Also, in the conventional ICP algorithm, failed convergence due to misalignment between point clouds may occur even when close to the optimal solution, for instance, if similar repetitive structures are present in the data. For example, points from inside and outside the same part of a mug with nearly identical curvature and only separated by the wall thickness. Especially, if only a part of the point cloud is available (e.g., due to self-occlusion of the object and/or missing data from a camera), ‘inside’and ‘outside’points are easily mismatched, leading to a shifted estimate.

As another example, the conventional ICP algorithm is usually an iterative algorithm, and may require a significant number of iterations. This may be caused, for example, by false point matches.

In view of the above, there is a need to provide an improved method for aligning point clouds, to enhance the robustness and performance of the point cloud alignment.

For example, it would be beneficial if the point cloud alignment did not require initial pose estimation. Also, enforcing point cloud alignment with important features, while avoiding local minima in near-symmetric poses may be desired. Further, avoiding mismatches of ‘inside’ and ‘outside’ points during the point cloud alignment would lead to better performance. There is also desire to reduce the number of iterations, which the method for point cloud alignment requires to reach a satisfactory alignment accuracy.

These and other benefits are achieved by the aspects and implementations described in this disclosure and in the independent claims. Advantageous but optional implementations are described in the dependent claims.

A first aspect of this disclosure provides a method for aligning a source point cloud corresponding to a 3D object with a target point cloud corresponding to the same 3D object, the method being performed by a processor, and the method comprising: receiving the source point cloud and the target point cloud as an input to the processor, wherein each point of a set of points in the source point cloud and each point of a set of points in the target point cloud is associated with at least one of a plurality of semantic labels; matching the source point cloud to the target point cloud, wherein the matching of each point of the set of points in the source point cloud is constrained to a point or points of the set of points in the target point cloud associated with the same or a similar semantic label; and applying a transformation operation to the source point cloud according based on a result of the matching.

Thus, points in the two point clouds may have additional label information provided by the semantic labels. Each point of the set of points of the respective point cloud comprises such label information. A set of points may include one or more or all points of the respective point cloud. When determining matching points in the source point cloud and the target point cloud, matches of at least one point in the source point cloud are constrained to one or more points in the target point cloud having the same or similar label. This may ensure that points from different categories (having different semantic labels) are not incorrectly matched. This further enables calculating the best transformation (e.g., rotation and/or translation) to align the points of the point clouds as closely as possible.

Advantageously, it turns out that the method of the first aspect almost always converges to a global minimum from arbitrary initial poses of the object, and thus does not require initial pose estimation. Nonetheless, an initial pose estimation could still be made, for instance, with random sample consensus (RANSAC). Further, due to the semantic labeling of points in the point clouds, the above-mentioned ‘inside’ and ‘outside’ issue may be avoided. Further, the number of iterations, which the method requires to reach an accurate alignment, can be strongly reduced, even zero repetitions are possible. This is, because false point matches are much less likely that, for example, with a conventional ICP algorithm, due to the semantic labeling.

In an implementation of the method, the set of points in respectively the source point cloud and the target point cloud comprises a first subset of points associated with a first semantic label and a second subset of points associated with a second semantic label.

Thus, at least two different semantic labels may be present in each point cloud, and may be used for matching points. Naturally, more than two semantic labels are possible and typical. The more semantic labels are used, the more accurate the alignment may be.

In an implementation of the method, matching the source point cloud to the target point cloud comprises: determining, for each point of the first subset of points in the source point cloud, a matching point of the first subset of points in the target point cloud; and determining, for each point of the second subset of points in the source point cloud, a matching point of the second subset of points in the target point cloud; and determining the transformation operation such that, when it is applied to the source point cloud, it aligns matching points as closely as possible.

In this way, an exemplary semantically based matching operation can be implemented.

In an implementation of the method, matching the source point cloud to the target point cloud comprises resampling at least one of the first subset of points and the second subset of points in the source point cloud and the target point cloud, in order to reduce their respective number of points.

For example, if some object parts contain more points than others, the larger parts (e.g., a mug body, if the object is a mug) may dominate the matching process, and may prevent correct alignment of smaller parts (e.g., a mug handle of the mug). Resampling or subsampling of points from labeled subset of points in a point cloud can be used to reduce or mitigate this effect.

In an implementation of the method, the transformation operation is determined based on a minimization of a geometric error metric between matching points in the source point cloud and the target point cloud.

For example, a mean squared error between the matching points may be minimized.

In an implementation of the method, the association of the points of the set of points in respectively the source point cloud and the target point cloud with the semantic labels is determined using one of a semantic segmentation algorithm and a semantic segmentation network.

For instance, the semantic labels can be derived from a prior semantic image segmentation, manual annotation, or another labeling process. For example, image segmentation may be provided by a network (e.g. neural network, like a convolutional neural network) trained for a specific problem or by a more generic or foundational model.

In an implementation of the method, determining the association of the points of the set of points in the source point cloud or the target point cloud with the semantic labels comprises: applying a semantic image segmentation to a source image or a target image corresponding to the 3D object, so as to associate each pixel of a set of pixels of said image with one of the plurality of semantic labels; and computing the source or target point cloud from the labeled source or target image, wherein each point of the set of points in the source or target point cloud is associated with the same one of the plurality of semantic labels as the corresponding pixel.

For example, semantic labels can be computed ahead of registration time. For instance, by deriving the target point cloud (also referred to as reference point cloud or reference model) from an image of the object, e.g., by conventional means. However, departing from the conventional means, semantic image segmentation can be applied to that image before converting it into the target point cloud. The image segmentation provides labels to parts of the image, e.g., pixels or pixel groups. By associating these labels with the nearest points in the target point cloud derived from the image, the points of the target point cloud can be automatically labeled. Optionally, this process is performed multiple times from multiple image perspectives, in order to get information on otherwise occluded parts of the object or to minimize imperfections of the segmentation process like border effects or missing data.

In an implementation of the method, for each point of the set of points in respectively the source point cloud and the target point cloud, a probability distribution is determined, wherein the probability distribution indicates probabilities of said point to be associated with respectively multiple or all semantic labels of the plurality of semantic labels.

Not all labels of a given point derived from different perspectives may result in identical labels. A part can belong to multiple overlapping categories, where its role and classification may depend on the context and level of abstraction. A cup handle, for example, is also part of a cup body. Thus, instead of deriving one single label per point in the set of points, a histogram of label information can be generated for any point. The histogram may approximate a probability distribution that identifies the point with the plurality of semantic labels. This histogram or distribution can be used for influencing the matching process and/or a loss function of the method used in the matching or transformation.

Another cause of non-unique label information can be due to visual ambiguities or shortcomings of the labeling system or border interpolation issues. Notably, the method of the first aspect does not depend on “correct” meaningful labels, but much more on consistency of labeling-if some object parts are consistently labeled “wrongly” between a reference model (for the target point cloud) and a measured model (for the source point cloud, they still contribute to pose estimation.

In an implementation of the method, at least one point in the source point cloud and at least one point in the target point cloud is not associated with any semantic label.

In an implementation of the method, the matching of each unlabeled point in the source point cloud to a point in the target point cloud is unconstrained; or constrained to an unlabeled point of the target point cloud.

In an implementation of the method, matching the source point cloud to the target point cloud comprises excluding points without a valid associated semantic label; or including points without a valid associated semantic label but with a reduced weight compared to points with a valid associated semantic label.

For example, labeling of a part is typically not complete, e.g., some points in the point cloud corresponding to the object may remain unlabeled. Reason may be that the labeling system has not been trained on such a part. The unlabeled points can still carry information, and may be used for point cloud registration as in classical ICP algorithms in a number of ways. For instance, “wildcard matching” of any unlabeled points in the source and/or target point cloud may be associated with any point in the other point cloud. Alternatively, “restrictive matching” may treat unlabeled points as a separate parts category and only match unlabeled to unlabeled points. Additionally, unlabeled points may be used with a lower weighting factor for computing the loss function than labeled points.

In an implementation of the method, the similar label is determined by at least one of: a predefined hierarchy or ontology; a computational reasoning; a large language model (LLM).

For example, if no exact label match is found, label similarity can be determined by a predefined hierarchy or ontology, or by computational reasoning, e.g. using the LLM.

In an implementation of the method, the step of matching the source point cloud to the target point cloud and the step of applying the transformation operation to the source point cloud are repeated one or more times, until a predetermined alignment accuracy of the source point cloud with the target point cloud is reached.

In an implementation of the method, the transformation operation comprises at least one of a rotation and a translation of the source point cloud.

The method of the first aspect also provides an option for scaled and non-rigid matching. For example, a measured parts-annotated point cloud can be used to relax requirements from rigid exactly scaled matching between target point cloud and source point cloud. This may be relevant if the object has a known shape but may be present in unknown scale, or if the object additionally may be non-homogeneously scaled (e.g. the body of a measured mug corresponding to the source point cloud is higher than the model corresponding to the target point cloud). While with a conventional ICP algorithm also the measured source point cloud may be rescaled to best match the target point cloud, especially in partial measurements relevant to robotics, such a rescaling is often practically impossible. In the approach of the method of the first aspect, knowledge of object parts in the measurements gives additional information of relative distances between parts that can be compared to the respective distances in the model, and thus have a better informed estimate of the scaling.

A second aspect of this disclosure provides a method for aligning a source Gaussian splatting corresponding to a 3D object with a target Gaussian splatting corresponding to the same 3D object, the method being performed by a processor, and the method comprising: receiving the source Gaussian splatting and the target Gaussian splatting as an input to the processor, wherein each Gaussian of a set of Gaussians in the source Gaussian splatting and each Gaussian of a set of Gaussian in the target Gaussian splatting is associated with at least one of a plurality of semantic labels; matching the source Gaussian splatting to the target Gaussian splatting, wherein the matching of each Gaussian of the set of Gaussians in the source Gaussian splatting is constrained to a Gaussian or Gaussians of the set of Gaussians in the target Gaussian splatting associated with the same or a similar semantic label; and applying a transformation operation to the source Gaussian splatting based on a result of the matching.

Recently, Gaussian splattings have become candidates for 3D rendering and reconstruction of 3D scenes and objects, and are a possible replacement of point clouds. Instead of points, a Gaussian splatting comprises 3D Gaussians (referred to as “splats”) with position, orientation, and anisotropic covariance. A Gaussian splatting allows for a smoother, more continuous scene reconstruction compared to the discrete point samples of a point cloud.

The method of the second aspect may comprise implementations that correspond to the implementations of the method of the first aspect, wherein point clouds are replaced by Gaussian splattings, and points are replaced by Gaussians. The entire concept of semantic labeling presented in this disclosure, is applicable to Gaussian splattings as for the point clouds.

A third aspect of this disclosure provides an image processing device for aligning a source point cloud corresponding to a 3D object, with a target point cloud corresponding to the same 3D object, the image processing device comprising a processor configured to: receive the source point cloud and the target point cloud as an input to the processor, wherein each point of a set of points in the source point cloud and each point of a set of points in the target point cloud is associated with at least one of a plurality of semantic labels; match the source point cloud to the target point cloud, wherein the matching of each point of the set of points in the source point cloud is constrained to a point or points of the set of points in the target point cloud associated with the same or a similar semantic label; and apply a transformation operation to the source point cloud based on a result of the matching.

In an implementation of the image processing device, the image processing device is or is part of one of the following: a robotics device; a computer vision device; a medical imaging device; an autonomous driving device; a vehicle.

The image processing device of the second aspect may have implementations that correspond to the implementations described for the method of the first aspect. That is, the processor may carry out also the steps of the additional method implementations. The image processing device of the second aspect and its possible implementations achieve the same effects and advantages that are described above with respect to the method of the first aspect and its possible implementations.

According to the above, the image processing device may work with Gaussian splattings rather than point clouds, else, everything is identical.

A fourth aspect of this disclosure provides a computer program comprising instructions which, when the computer program is executed by a processor, causes the processor to perform the method of the first aspect.

A fifth aspect of this disclosure provides a non-transitory storage medium storing executable program code which, when executed by a processor, causes the method according to the first aspect or the second aspect to be performed.

It is noted that entities, elements, units and means described in this disclosure may be implemented by software or hardware or any kind of combination thereof. Steps performed by the entities described in this disclosure, as well as the functionalities described to be performed, mean that the respective entity is adapted to or configured to perform the respective steps and functionalities.

### BRIEF DESCRIPTION OF THE DRAWINGS

The above described aspects and implementations are explained in the following description of embodiments with respect to the enclosed drawings:

FIG. 1 shows a flow-diagram of a method for aligning point clouds according to this disclosure.

FIG. 2 illustrates schematically the function of a processor of an image processing device according this disclosure for point cloud alignment.

FIG. 3 shows a flow-diagram of an exemplary implementation of a step of determining a labeled point cloud.

FIG. 4 shows a flow-diagram of an exemplary implementation of a step of matching a source point cloud to a target point cloud.

FIG. 5 illustrates an example of semantic segmentation of a point cloud corresponding to a 3D object.

FIG. 6 illustrates a concept of constrained matching of points in the point clouds, according to the method of this disclosure.

### DETAILED DESCRIPTION

Illustrative examples of the method and the image processing device are described in the following, with reference to the above-mentioned figures. Although this description provides detailed examples and implementations, it should be noted that several details are intended to be exemplary and in no way limit the scope of the disclosure. For instance, the following description is based on the use of point clouds including points, but could be applied in an analogous manner to Gaussian splattings including Gaussians.

In the figures, same elements are labelled with the same reference signs, may be implemented likewise, and are possibly not be described redundantly.

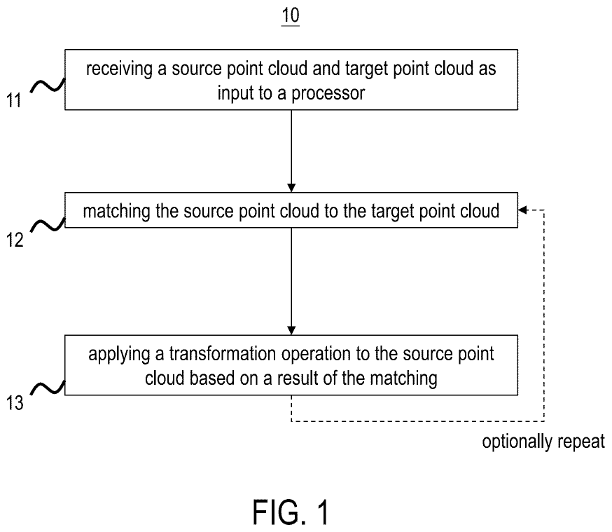

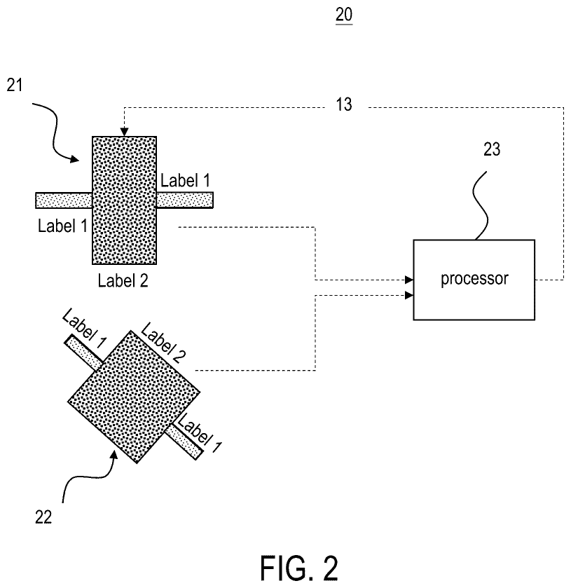

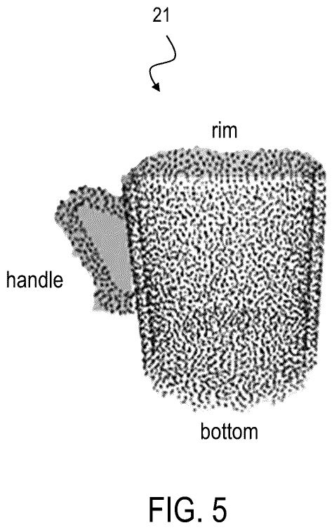

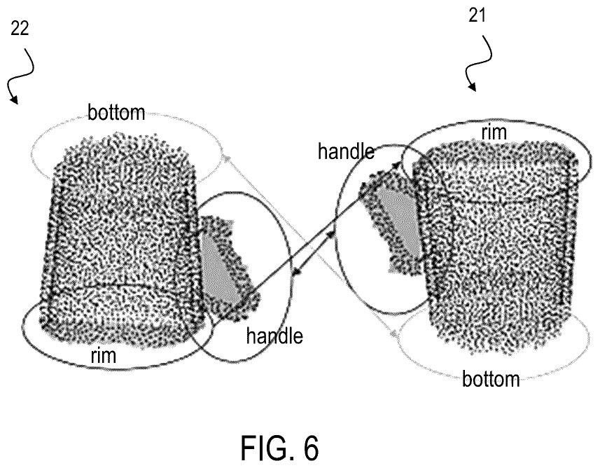

FIG. 1 shows a flow-diagram of a method 10 proposed in this disclosure. The method 10 is performed by a processor. For example, the method 10 may be executed by a processor 23 of an image processing device 20 according to this disclosure, which is schematically shown in FIG. 2. The processor 23 is configured to perform the steps of the method 10. The method 10 is used for aligning a source point cloud corresponding to a 3D object, to a target point cloud corresponding to the same 3D object. For instance, it can align the exemplary source point cloud 21 and the exemplary target point cloud 22 shown in FIG. 2, which include points associated with a first semantic label (Label 1) and points associated with a second semantic label (Label 2), respectively. It can also align the more specific point clouds 21, 22, which correspond to a mug as the object and are shown in FIG. 5 and FIG. 6.

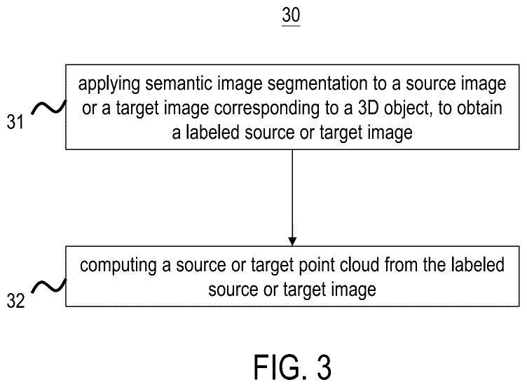

The method 10 comprises a step 11 of receiving the source point cloud 21 and the target point cloud 22 as an input to the processor 23. Each point of a set of points in the source point cloud 21 and each point of a set of points in the target point cloud 22 is associated with at least one of a plurality of semantic labels. The set of points may include at least one point in the respective point cloud 21, 22, or may include multiple points in the respective point cloud 21, 22, or may even include all points in the respective point cloud 21, 22. Notably, the source point cloud 21 and the target point cloud 22 may already be labeled when they are provided as input to the processor 23. However, it is also possible that the method 10 includes a step of determining, by the processor 23, the labeling of the source and the target point cloud 21, 22, respectively. An exemplary step will be described below with respect to FIG. 3.

The method 10 further comprises a step 11 of matching the source point cloud 21 to the target point cloud 22, wherein the points of the source point cloud 21 are matched to the target point cloud 22, for instance, multiple points or even (but not necessarily) all points of the source point cloud 21 can be matched. In particular, the matching of each point of the set of points in the source point cloud 21 is constrained to a point or points of the set of points in the target point cloud 22 that is/are associated with the same or a similar semantic label. Thus, the matching of labeled points is constrained to identically or at least similarly labeled points. For example, points in the set of points of the source point cloud 21 are not matched to points of the set of points in the target point cloud 22 that have a different label, or to points in the target point cloud 22 that have no label. Notably, similar labels may be determined by a predefined hierarchy or ontology, or a computational reasoning like with a LLM.

Further, the method 10 comprises a step 13 of applying a transformation operation to the source point cloud 21, based on the result of the matching. The transformation operation is applied taking into account the matching points determined during the matching step, which is the result of the matching. For example, the source point cloud 21 may be transformed by the transformation operation (e.g. comprising a rotation and/or a translation) to align matching points (may also be referred to as matched points or corresponding points) of the source point cloud 21 and the target point cloud 22 as closely as possible. As closely as possible may mean minimizing a geometric error metric-for instance a mean squared error-between matching points in the source point cloud 21 and the target point cloud 22.

The step 12 of matching the source point cloud 21 to the target point cloud 22, and the step 13 of applying the transformation operation to the source point cloud 22, can optionally be repeated one or more times, as indicated in FIG. 1 by the dashed arrow. For example, until a predetermined alignment accuracy of the source point cloud with the target point cloud is reached, or until a predetermined number of repetitions is reached. Thus, the method 10 may iteratively align the point clouds 21, 22 with each other. Accordingly, the method 10 may be an ICP-like method that uses semantic segmentation. Repetition is not strictly necessary, however, due to the benefits of the labeling.

A point cloud may be a collection of data points in 3D space, which may represent a surface geometry of an object. Each point in the point cloud may be defined by (x, y, z) coordinates, and can also include extra information like color or intensity. Point clouds could be generated by 3D scanners, or could be derived from 3D reconstruction methods. Point clouds could also be derived from images, for instance, from a RGB-D image having both color (RGB) and depth (D) information. Each pixel of the image may contribute a 3D coordinate and associated color data to the point cloud.

The target point cloud 21 may be a reference point cloud, which may, for example, be derived from a reference image of the object. The source point cloud 22 may be a computed or measured point cloud, which may, for example, be derived from a measurement of the object. For example, the measurement may be an image of the object taken by a camera or similar.

The processor 23 may be a processor of any one of a robotics device, a robot, a computer vision device, a camera, a medical imaging device, a scanner, an autonomous driving device, and a vehicle. Other devices that include the processor are possible. This means, any one of the above devices may perform, using its processor, the method. The method 10 may accordingly be used for the purpose of controlling a robot or medical instrument. The method 10 may also be used for the purpose of autonomously driving a vehicle.

Matching points of two point clouds may refer to finding points in the two point clouds, for example, identifying closest or most similar points in the two point clouds, which have the same or similar label.

A semantic label (or short just ‘label’) may be a category or meaning assigned to a point in a point cloud (or a pixel of an image), which indicates what it represents in an object (e.g., whether a point or pixel represents or belong to a “handle,” “bottom,” or “rim”, if the object is a mug). A semantic label in this disclosure may also indicate an appearance a point in a point cloud represents (e.g., “blue” or “shiny”), or may indicate a material the point represents (e.g., “plastic” or “metal”), or may indicate a geometry the point represents (“flat” or “triangular”), or may indicated a texture the point represents (“rough” or “smooth”), or a function, or another type of label that can be derived, for instance, from an image.

Applying a transformation operation on a point cloud, may referred to transforming the point cloud, may involve the process of changing the positions of multiple or all points in the point cloud according to a particular rotation and/or translation, in order to move or align the point cloud in 3D space (e.g. with another point cloud).

An application example for the method 10 is an intelligent tele-robotics assistance system, which can help an operator to precisely align a robotic hand with an object. Ideally, without the operator even noticing this assistance. To achieve this, the assistance system may estimate the pose of the object (e.g., its orientation and position), for instance, if the object is provided on a work surface. Such a pose-estimation task of the system can be approached as a point cloud alignment. For instance, during this task, a point cloud representing the object (e.g., obtained from RGB-D imaging of the object, which provides both color and depth information) is to be aligned with a target point cloud (reference point cloud) of the same object. The optimum alignment is related to a transformation. The transformation may reveal the pose of the object, and can be used to control the robot, for instance, to control the robotic hand of the robot to handle the object.

FIG. 3 shows a flow-diagram of an exemplary implementation of a possible step 30 of determining a labeled point cloud. The step 30 may be performed before the receiving step 11 (e.g. by other means than the processor 23). Alternatively, if carried out by the processor 23, the step may be performed between steps 11 and 12.

The step 30 may include a sub-step 31 of applying a semantic image segmentation to a source image or a target image corresponding to the 3D object, so as to associate each pixel of a set of pixels of said image with one of the plurality of semantic labels. This obtains a labeled source or target image. Whether the source image or target image is used in the step 30 (or both) depends on whether the source point cloud 21 or target point cloud 22 (or both) is to be labeled. For the semantic image segmentation, conventional means may be used. For example, a conventional semantic image segmentation network or algorithm may be used.

The step 30 further comprises a sub-step 32 of computing the source or target point cloud from the labeled source or target image (or both). In this sub-step 32, each point of the set of points in the source or target point cloud is associated with the same one of the plurality of semantic labels as the corresponding pixel.

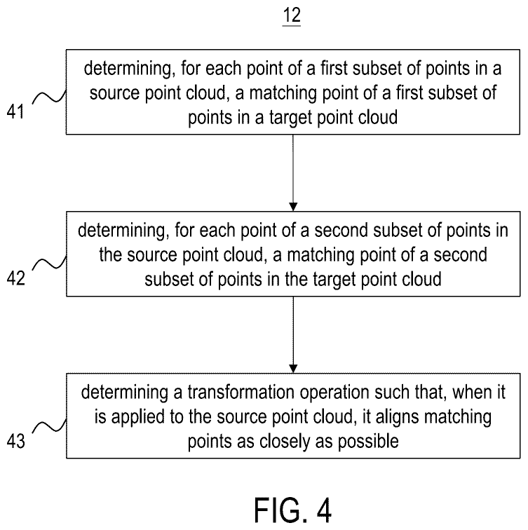

FIG. 4 shows a flow-diagram of an exemplary implementation of the step 12 of the method 10, i.e., of matching the source point cloud 21 to the target point cloud 21. In this example, the set of points in respectively the source point cloud 21 and the target point cloud 22 comprises a first subset of points associated with a first semantic label, and a second subset of points associated with a second semantic label. Of course, each set of points may comprise more subsets of points associated with other labels, and the skilled person can transfer the exemplary step 12 accordingly.

The step 12 may include a sub-step 41 of determining, for each point of the first subset of points in the source point cloud 21, a matching point of the first subset of points in the target point cloud 22. The matching point has the same or similar label. Else, the matching point may be the closest or most similar point, of such points having the same or similar label, in the target point cloud 23.

The step 12 may further include a sub-step 42 of determining, for each point of the second subset of points in the source point cloud 21, a matching point of the second subset of points in the target point cloud 22. Also here the matching point has the same or similar label, and may else be the closest or most similar point, of such points having the same or similar label, in the target point cloud 23.

The step 12 may further include a sub-step 43 of determining the transformation operation such that, when it is applied to the source point cloud 21, the transformation operation aligns matching points (previously matched) as closely as possible, for instance, with a minimized error metric. For example, a means squared error (e.g., alignment error) between matched points can be minimized.

In the following, some exemplary details of the method 10 are described with respect to the particular example of the object (mug), which is shown in FIG. 5 and FIG. 6. As can be understood from the description above, the method 10 combines semantic labeling with ICP-like steps. For example, the method 10 may combine semantic segmentation of images of objects with an ICP-like algorithm (“ICP-like” denoting that it is similar with, in that has features of, the convention ICP algorithm, but needs not be identical). This may be realized by constraining point matches in the ICP-like algorithm to points in the target point cloud (as illustrated in FIG. 6). An exemplary implementation of the method 10 may comprise the following steps.
Input: An RGB-D image I, optional an object mask M,
Step 1: apply a semantic segmentation network to segment the pixels of the image I (or of a subset of pixels corresponding to M in I) into object parts, and thus generate label information L for each pixel (see FIG. 5).
Step 2: use the label information L to build a list L of pixels for each object part type (e.g., one list each for “rim”, “handle”, “body”, and “bottom” of the mug being the object).
Step 3: for each pixel set p_i in L, compute the partial point cloud pc_i and store in list PC_m (“point cloud measured”).
Step 4: load a reference model of the object (e.g., an annotated image of the object or directly a point cloud corresponding to the object) to get a list of parts-annotated reference point cloud PC_r (“point cloud reference”, the target point cloud). Note that this reference model may have been hand annotated, or automatically annotated, for example, before running the method 10.
Step 5: perform the ICP-like algorithm, e.g., steps like for the conventional ICP algorithm, except that point association is not strictly for nearest neighboring points as in the conventional ICP algorithm, but constrained to points within same part/segment type (see FIG. 6), i.e., points with the same or similar semantic label.
Output: apply a relative transformation between PC_m and PC_r.

In summary, this disclosure introduces improvements to the conventional ICP algorithm and approaches, and particularly enhances the robustness and performance of point cloud registration. Point cloud registration—i.e., the process of aligning two or more point clouds into a common coordinate system by estimating a transformation (e.g., a rotation and translation)—is a fundamental technology for many technical application areas, including robotics, computer vision, medical imaging, and autonomous driving. The method can be used whenever a 3D representation of an object and a reference point cloud or image (generally, 3D representation of the object) is available and when a parts segmentation of the object to be aligned is available. For example, point clouds can be derived from a mesh or neural distance function (NERF) or signed distance function (SDF) representation. A parts segmentation of the object to be aligned may be derived from an RGB image using a segmentation network.

In the claims as well as in the description of this disclosure, the word “comprising” does not exclude other elements or steps and the indefinite article “a” or “an” does not exclude a plurality. A single element may fulfill the functions of several entities or items recited in the claims. The mere fact that certain measures are recited in the mutual different dependent claims does not indicate that a combination of these measures cannot be used in an advantageous implementation.

1. A method for aligning a source point cloud corresponding to a three-dimensional, 3D, object, with a target point cloud corresponding to the same 3D object, the method being performed by a processor, and the method comprising:
receiving the source point cloud and the target point cloud as an input to the processor,
wherein each point of a set of points in the source point cloud and each point of a set of points in the target point cloud is associated with at least one of a plurality of semantic labels;
matching the source point cloud to the target point cloud,
wherein the matching of each point of the set of points in the source point cloud is constrained to a point or points of the set of points in the target point cloud associated with the same or a similar semantic label; and
applying a transformation operation to the source point cloud based on a result of the matching.

2. The method of claim 1, wherein
the set of points in respectively the source point cloud and the target point cloud comprises a first subset of points associated with a first semantic label and a second subset of points associated with a second semantic label.

3. The method of claim 2, wherein matching the source point cloud to the target point cloud comprises:
determining, for each point of the first subset of points in the source point cloud, a matching point of the first subset of points in the target point cloud; and
determining, for each point of the second subset of points in the source point cloud, a matching point of the second subset of points in the target point cloud; and
determining the transformation operation such that, when it is applied to the source point cloud, it aligns matching points as closely as possible.

4. The method according to claim 2, wherein matching the source point cloud to the target point cloud comprises
resampling at least one of the first subset of points and the second subset of points in the source point cloud and the target point cloud, in order to reduce their respective number of points.

5. The method of claim 1, wherein the transformation operation is determined based on a minimization of a geometric error metric between matching points in the source point cloud and the target point cloud.

6. The method of claim 1, wherein
the association of the points of the set of points in respectively the source point cloud and the target point cloud with the semantic labels is determined using one of a semantic segmentation algorithm and a semantic segmentation network.

7. The method of claim 6, wherein determining the association of the points of the set of points in the source point cloud or the target point cloud with the semantic labels comprises:
applying a semantic image segmentation to a source image or a target image corresponding to the 3D object, so as to associate each pixel of a set of pixels of said image with one of the plurality of semantic labels; and
computing the source or target point cloud from the labeled source or target image,
wherein each point of the set of points in the source or target point cloud is associated with the same one of the plurality of semantic labels as the corresponding pixel.

8. The method of claim 1, wherein
for each point of the set of points in respectively the source point cloud and the target point cloud, a probability distribution is determined, wherein the probability distribution indicates probabilities of said point to be associated with respectively multiple or all semantic labels of the plurality of semantic labels.

9. The method of claim 1, wherein
at least one point in the source point cloud and at least one point in the target point cloud is not associated with any semantic label.

10. The method of claim 9, wherein the matching of each unlabeled point in the source point cloud to a point in the target point cloud is
unconstrained; or
constrained to an unlabeled point of the target point cloud.

11. The method of claim 1, wherein matching the source point cloud to the target point cloud comprises
excluding points without a valid associated semantic label; or
including points without a valid associated semantic label but with a reduced weight compared to points with a valid associated semantic label.

12. The method of claim 1, wherein the similar label is determined by at least one of:
a predefined hierarchy or ontology;
a computational reasoning;
a large language model, LLM.

13. The method according to claim 1, wherein
the step of matching the source point cloud to the target point cloud and the step of applying the transformation operation to the source point cloud are repeated one or more times, until a predetermined alignment accuracy of the source point cloud with the target point cloud is reached or until a predetermined number of repetitions is reached.

14. The method of claim 1, wherein the transformation operation comprises at least one of a rotation and a translation of the source point cloud.

15. A method for aligning a source Gaussian splatting corresponding to a three-dimensional, 3D, object, with a target Gaussian splatting corresponding to the same 3D object, the method being performed by a processor, and the method comprising:
receiving the source Gaussian splatting and the target Gaussian splatting as an input to the processor,
wherein each Gaussian of a set of Gaussians in the source Gaussian splatting and each Gaussian of a set of Gaussians in the target Gaussian splatting is associated with at least one of a plurality of semantic labels;
matching the source Gaussian splatting to the target Gaussian splatting,
wherein the matching of each Gaussian of the set of Gaussians in the source Gaussian splatting is constrained to a Gaussian or Gaussians of the set of Gaussians in the target Gaussian splatting associated with the same or a similar semantic label; and
applying a transformation operation to the source Gaussian splatting based on a result of the matching.

16. An image processing device for aligning a source point cloud corresponding to a three-dimensional, 3D, object, with a target point cloud corresponding to the same 3D object, the image processing device comprising a processor configured to:
receive the source point cloud and the target point cloud as an input to the processor,
wherein each point of a set of points in the source point cloud and each point of a set of points in the target point cloud is associated with at least one of a plurality of semantic labels;
match the source point cloud to the target point cloud,
wherein the matching of each point of the set of points in the source point cloud is constrained to a point or points of the set of points in the target point cloud that is associated with the same or a similar semantic label; and
apply a transformation operation to the source point cloud based on a result of the matching.

17. The image processing device of claim 16, wherein the image processing device is or is part of one of the following:
a robotics device;
a computer vision device;
a medical imaging device;
an autonomous driving device;
a vehicle.

18. A computer program comprising instructions which, when the computer program is executed by a processor, causes the processor to perform the method of claim 1.

19. A computer program comprising instructions which, when the computer program is executed by a processor, causes the processor to perform the method of claim 15.
